(19) United States
(12) Patent Application Publication
(10) Pub. No.: US 2024/0190713 A1
(43) Pub. Date: Jun. 13, 2024

(54) SYSTEMS AND PROCESSES FOR PRODUCING AMMONIUM SULFATE FROM WASTE STREAMS

(71) Applicant: Marsulex Environmental Technologies Corporation, Pensacola, FL (US)

(72) Inventors: Michael Hammer, Birdsboro, PA (US); Bronwyn Graeffe, Lititz, PA (US)

(21) Appl. No.: 18/311,492

(22) Filed: May 3, 2023

Related U.S. Application Data
(60) Provisional application No. 63/386,706, filed on Dec. 9, 2022.

(51) Int. Cl. C01C 1/244; C01G 21/14; C22B 3/00; H01M 10/54

(52) U.S. Cl. CPC C01C 1/244; C01G 21/14; C22B 13/045; H01M 10/54

(57) ABSTRACT

Systems and processes for producing ammonium sulfate that include providing an industrial waste material that includes at least lead sulfate and sulfuric acid. Ammonium hydroxide is added to the industrial waste material to raise the pH thereof and react the sulfuric acid to produce ammonium sulfate, and the lead sulfate is reacted with ammonium carbonate to produce lead carbonate.

### CROSS-REFERENCE TO RELATED APPLICATIONS

This application claims the benefit of U.S. Provisional Application No. 63/386,706 filed Dec. 9, 2022, the contents of which are incorporated herein by reference.

### BACKGROUND OF THE INVENTION

The present invention generally relates to production of useful compounds from waste streams. The invention particularly relates to systems and processes capable of producing ammonium sulfate from an industrial waste material that contains lead sulfate, such as lead paste of a battery.

Traditional methods for recovering lead paste (predominantly lead sulfate, PbSO₄) from lead batteries utilize sodium or calcium as the reagent to neutralize the battery acid (sulfuric acid (H₂SO₄) as an electrolyte) present in the lead paste. In an exemplary process, a slurry of lead paste is reacted with sodium carbonate or calcium carbonate, and the reaction products are sodium sulfate (Na₂SO₄) or calcium sulfate (CaSO₄). Sodium sulfate is highly soluble and if produced can be disposed of as a liquid waste stream or processed in a crystallizer and disposed of as a solid waste. More stringent discharge regulations are being adopted for liquid waste streams and sodium sulfate liquid waste streams are not or will no longer be allowed to be discharged without a post-treatment process, i.e., crystallization, yielding a solid waste that is deemed hazardous. Calcium sulfate produced from such processes is in solid form and must be disposed of via landfill at a cost.

Ammonium sulfate ((NH₄)₂SO₄) fertilizers can be added to soils that are lacking an adequate supply of nitrogen to contribute nitrogen for plant growth and lower the pH balance of the soil. Ammonium sulfate can be produced by treating ammonia (NH₃) with sulfuric acid or with an ammonium carbonate ((NH₄)₂CO₃) solution.

It would be desirable if systems and/or processes were available that were capable of recovering lead paste from lead batteries to produce more useful reaction products, such as ammonium sulfate.

### BRIEF DESCRIPTION OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems and processes for producing useful compounds from waste streams.

According to a nonlimiting aspect of the invention, a process is provided for producing ammonium sulfate that includes providing an industrial waste material that includes at least lead sulfate and sulfuric acid. Ammonium hydroxide is added to the industrial waste material to raise the pH thereof and react the sulfuric acid to produce ammonium sulfate, and the lead sulfate is reacted with ammonium carbonate to produce lead carbonate.

According to another nonlimiting aspect of the invention, a system is provided for producing ammonium sulfate and is capable of performing steps of a process as described above.

Technical effects of processes and systems having features as described above preferably include the capability of producing ammonium sulfate as a saleable by-product. Lead carbonate is also produced, which is a feed stock to lead refining processes. Additionally, the process can utilize ammonia (NH₃) and carbon dioxide (CO₂) in place of sodium and calcium-based reagents in lead battery recycling processes traditionally employed to recover lead paste. Eliminating sodium and calcium-based reagents from lead battery recycling processes avoids disposal costs and waste management needs. Reacted lead carbonate from the use of ammonia is also capable of having relatively lower sulfur contents than lead paste reacted with sodium or calcium reagents. Utilizing the reacted lead carbonate produced from the ammonia reaction in refining furnaces decreases the sulfur emissions in the gases exiting the furnaces.

Other aspects and advantages of this invention will be appreciated from the following detailed description.

### BRIEF DESCRIPTION OF THE SEVERAL VIEWS OF THE DRAWING

FIG. 1 schematically represents a system and process for producing ammonium sulfate from an industrial waste steam that contains lead sulfate in accordance with a nonlimiting embodiment of this invention.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of the embodiment(s). The following detailed description also identifies certain but not all alternatives of the embodiment(s). As nonlimiting examples, the invention encompasses additional or alternative embodiments in which one or more features or aspects described as part of a particular embodiment could be eliminated, and also encompasses additional or alternative embodiments that combine two or more features or aspects described as part of different embodiments. Therefore, the appended claims, and not the detailed description, are intended to particularly point out subject matter regarded to be aspects of the invention, including certain but not necessarily all of the aspects and alternatives described in the detailed description.

The present disclosure relates to systems and processes that may be used to produce ammonium sulfate ((NH₄)₂SO₄), including but not limited to agricultural grade ammonium sulfate, from waste streams that contain (or may be reacted to contain) lead sulfate (PbSO₄). Broadly, the systems and processes involve reactions between ammonium hydroxide (NH OH) and ammonium carbonate ((NH₄)₂CO₃) and industrial waste materials that contain lead sulfate to produce ammonium sulfate as a high-value usable byproduct, as well as recover lead metal from the industrial waste material. In a particular example, the industrial waste material is or contains lead sulfate and sulfuric acid (H₂SO₄). The ammonium hydroxide increases the low pH of the industrial waste material resulting from its sulfuric acid content and converts at least some of the sulfuric acid to ammonium sulfate. With the pH increased to a suitable level, ammonium carbonate can then be added to react with and convert at least some of the lead sulfate to lead carbonate (PbCO₃) and additional ammonium sulfate.

Though the process can be applied to lead sulfate waste streams generated by various industries, waste streams of particular interest are believed to be those generated by recycling of batteries, including the recovery of their lead paste (predominantly lead sulfate) and spent electrolyte (sulfuric acid as the battery acid). In this particular example, the industrial waste material is or contains a lead paste and sulfuric acid from one or more lead batteries. The ammonium hydroxide increases the inherently low pH of the lead paste resulting from its sulfuric acid content and converts at least some of the sulfuric acid to ammonium sulfate. With the pH of the lead paste increased to a suitable level, the ammonium carbonate reacts with and converts at least some of the lead sulfate to lead carbonate and additional ammonium sulfate. As such, one aspect is to provide processes and systems that offer the ability to recycle lead batteries while simultaneously providing an economic benefit and/or eliminating or at least reducing certain industrial wastes by providing a more environmentally friendly alternative to the disposal of sodium sulfate and calcium sulfate waste materials. Additionally, a process as described above has the capability of reducing sulfur in the lead paste.

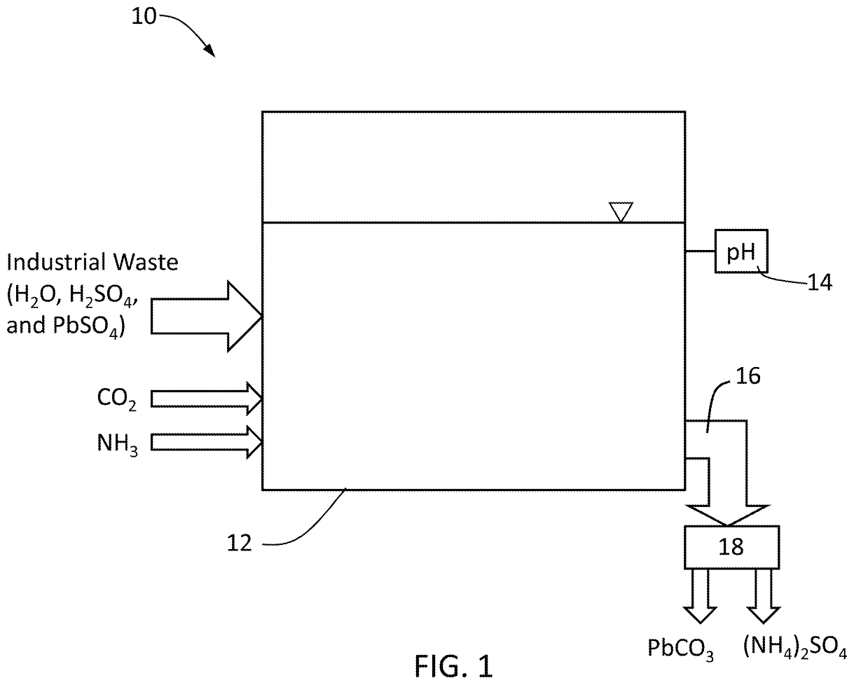

As schematically represented in FIG. 1, a preferred process can be performed with a single reaction tank (or other vessel) 12 of a lead recovery system 10 utilizing ammonia (NH₃) and carbon dioxide (CO₂) as the fundamental reagents. In particular, ammonium hydroxide (NH₄OH) can be produced within the tank 12 through the reaction of ammonia with water (H₂O) present in a lead paste and ammonium carbonate ((NH₄)₂CO₃) can be produced within the tank 12 through the reaction of ammonia and carbon dioxide with water present in a lead paste according to the following reactions.

NH₃+H₂O→NH₄OH

2NH₃+H₂O+CO₂→(NH₄)₂CO₃

Prior to being introduced into the tank 12, the ammonia and carbon dioxide can be processed in a manner to optimize the generation of the ammonium hydroxide used to raise the pH of the lead paste within the tank 12 (e.g., as monitored with a pH sensor 14) and produce ammonium sulfate from the sulfuric acid in the paste and the generation of the ammonium carbonate used to convert lead sulfate to lead carbonate. The reactions by which ammonia and carbon dioxide can be utilized within the tank 12 to generate ammonium hydroxide and ammonium sulfate are generally as follows:

H₂SO₄+PbSO₄+2((NH₄)OH)→(NH₄)₂SO₄+PbSO₄+2H₂O

(NH₄)₂SO₄+PbSO₄+2H₂O+(NH₄)₂CO₃→2(NH₄)₂SO₄+PbCO₃+2H₂O

Ammonium sulfate has a high solubility in water and is dissolved in the residual liquid due to the typically inherent amount of water contained in battery acid. The resultant material 16 is in slurry form; lead carbonate as a solid and ammonium sulfate dissolved in the water. The lead carbonate and ammonium sulfate of the material 16 can then be separated into solid lead carbonate and liquid ammonium sulfate via filtration 18. Optionally, the filtered lead carbonate can be further refined in the lead recovery system 10 to yield lead metal (Pb) and carbon dioxide. The ammonium sulfate in solution can be crystallized into solid ammonium sulfate as a valuable by-product that can be utilized as an agricultural fertilizer.

In view of the foregoing, the battery recycling and lead refining industries are believed to benefit from the system 10 and process described above as they reduce or eliminate the production of a liquid waste stream that contains sodium sulfate or calcium sulfate salts. The system 10 and process are also capable of increased sulfur reduction in the lead paste used for further refining to lead metal.

While the invention has been described in terms of particular embodiments, it is apparent that other forms could be adopted by one skilled in the art. For example, the process could be performed with systems utilizing multiple reaction vessels to perform continuous or batch processing of an industrial waste material and/or utilize various additional sensors and other components to monitor or facilitate the reactions of the process, and various other industrial waste materials could serve as the feedstock. As such, and again as was previously noted, it should be understood that the invention is not necessarily limited to any particular embodiment described herein.

1. A process for producing ammonium sulfate, the process comprising:
providing an industrial waste material that includes at least lead sulfate and sulfuric acid;
adding ammonium hydroxide to the industrial waste material to raise the pH thereof and react the sulfuric acid to produce ammonium sulfate; and
reacting the lead sulfate with ammonium carbonate to produce lead carbonate.

2. The process of claim 1, wherein the industrial waste material comprises a lead paste obtained from lead batteries.

3. The process of claim 2, wherein the lead paste comprises the lead sulfate.

4. The process of claim 2, wherein the lead paste comprises the sulfuric acid as an electrolyte.

5. The process of claim 1, wherein the ammonium hydroxide is produced by reacting ammonia with water in the industrial waste material.

6. The process of claim 1, wherein the ammonium carbonate is produced by reacting ammonia and carbon dioxide with water in the industrial waste material.

7. The process of claim 1, further comprising processing the ammonium sulfate to produce solid ammonium sulfate.

8. The process of claim 7, wherein the processing of the ammonium sulfate comprises a crystallization process.

9. The process of claim 1, further comprising processing the lead carbonate to produce lead metal.

10. A system for producing ammonium sulfate by the process of claim 1, the system comprising:
a tank containing the industrial waste material and in which the ammonium hydroxide is added or generated to raise the pH and react the sulfuric acid to produce the ammonium sulfate and in which the lead sulfate is reacted with the ammonium carbonate to produce the lead carbonate.

11. The system of claim 10, further comprising means for introducing ammonia into the tank to produce the ammonium hydroxide by reacting the ammonia with water in the industrial waste material.

12. The system of claim 10, further comprising means for ammonia and carbon dioxide into the tank to produce the ammonium carbonate by reacting the ammonia and the carbon dioxide with water in the industrial waste material.
